(19) United States
(12) Patent Application Publication
(10) Pub. No.: US 2026/0160212 A1
(43) Pub. Date: Jun. 11, 2026

(54) INTERNAL COMBUSTION ENGINE CONTROLLER

(71) Applicant: TOYOTA JIDOSHA KABUSHIKI KAISHA, Toyota-shi (JP)

(72) Inventor: Taichi NISHIMURA, Toyota-shi (JP)

(21) Appl. No.: 19/399,677

(22) Filed: Nov. 25, 2025

(30) Foreign Application Priority Data
Dec. 11, 2024 (JP) 2024-216410

(51) Int. Cl. F02D 41/00; F02D 1/02

(52) U.S. Cl. CPC F02D 41/0045; F02D 1/02; F02D 41/008; F02D 2200/0606; F02D 2200/0612

(57) ABSTRACT

A controller is employed for an internal combustion engine capable of using a fuel containing ethanol. The internal combustion engine includes multiple cylinders, multiple fuel injection valves, an intake passage, and a purge port. The purge port discharges purge gas containing fuel vapor generated in the fuel tank to the intake passage. The processing circuitry of the controller individually corrects fuel injection amounts of the fuel injection valves such that a fuel injection amount of the fuel injection valve corresponding to a cylinder into which a large amount of the purge gas is introduced is smaller than a fuel injection amount of the fuel injection valve corresponding to a cylinder into which a small amount of the purge gas is introduced.

### CROSS-REFERENCE TO RELATED APPLICATIONS

This application is based upon and claims the benefit of priority from Japanese Patent Application No. 2024-216410, filed on Dec. 11, 2024, the entire contents of which are incorporated herein by reference.

### BACKGROUND

### 1. Field

The present disclosure relates to an internal combustion engine controller for an internal combustion engine capable of using a fuel containing ethanol.

### 2. Description of Related Art

JP2021-76059A discloses an internal combustion engine capable of using a fuel containing alcohol, and a controller for the internal combustion engine. The internal combustion engine includes multiple cylinders, multiple fuel injection valves, and a purge system. The fuel injection valves are provided in correspondence to the respective cylinders. The purge system discharges purge gas containing fuel vapor generated in the fuel tank to the intake passage.

The controller calculates a learned value for compensating for a deviation between a detection value and a target value of an air-fuel ratio caused by the purge system releasing the purge gas into the intake passage. The controller then corrects the fuel injection amount of the fuel injection valves based on the learned value.

The above-described purge system releases purge gas into the intake passage through a purge port connected to the intake passage. The purge gas released into the intake passage is introduced into the cylinders. The amount of purge gas introduced into the cylinders varies. Accordingly, when purge gas is released into the intake passage, the amount of purge gas introduced into the respective cylinders may vary, which can cause the air-fuel ratio of the mixture combusted in each cylinder to vary from cylinder to cylinder.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an internal combustion engine controller for controlling an internal combustion engine is provided. The internal combustion engine is capable of using a fuel containing ethanol. The internal combustion engine includes multiple cylinders, multiple fuel injection valves respectively corresponding to the cylinders, an intake passage through which air is drawn into the cylinders, and a purge port that discharges purge gas containing fuel vapor generated in a fuel tank to the intake passage. The internal combustion engine controller includes processing circuitry configured to control fuel injection amounts of the fuel injection valves. The processing circuitry is configured to execute a per-cylinder correction process that individually corrects fuel injection amounts of the fuel injection valves such that a fuel injection amount of the fuel injection valve corresponding to a cylinder into which a large amount of the purge gas is introduced among the multiple cylinders is smaller than a fuel injection amount of the fuel injection valve corresponding to a cylinder into which a small amount of the purge gas is introduced.

Other features and aspects will be apparent from the following detailed description, the drawings, and the claims.

### BRIEF DESCRIPTION OF THE DRAWINGS

FIG. 1 is a schematic diagram showing the configuration of an internal combustion engine controller according to an embodiment, and the configuration of an internal combustion engine controlled by the controller.

FIG. 2 is a schematic diagram showing a state in which purge gas discharged from a purge port to an intake passage flows toward cylinders.

FIG. 3 is a block diagram showing multiple processes executed by processing circuitry included in the controller shown in FIG. 1.

FIG. 4 is a flowchart showing an example of a concentration estimation process of FIG. 3.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

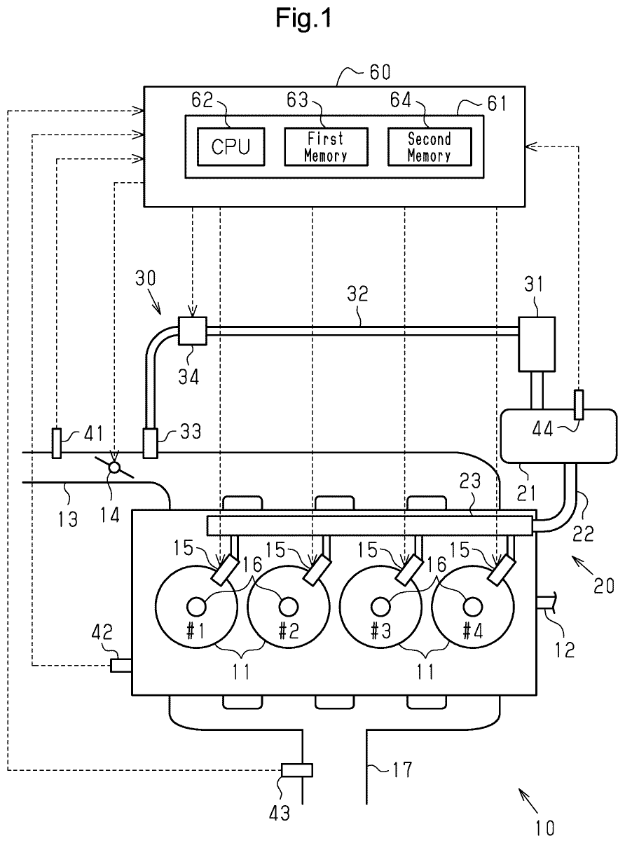

An embodiment of an internal combustion engine controller will be described with reference to FIGS. 1 to 4.

FIG. 1 shows an internal combustion engine 10 and a controller 60 applied to the internal combustion engine 10. The controller 60 corresponds to the “internal combustion engine controller.”

### Configuration of the Internal Combustion Engine 10

The internal combustion engine 10 can use a fuel containing ethanol. The fuel includes, for example, at least ethanol among ethanol and gasoline. The internal combustion engine 10 can also use fuel containing only gasoline.

The internal combustion engine 10 includes multiple cylinders 11, a crankshaft 12, an intake passage 13, multiple fuel injection valves 15, multiple ignition plugs 16, and an exhaust passage 17. The multiple cylinders 11 include a first cylinder #1, a second cylinder #2, a third cylinder #3, and a fourth cylinder #4 that are arranged in order in a direction in which the crankshaft 12 extends.

Air to be introduced into the multiple cylinders 11 flows through the intake passage 13. The intake passage 13 is provided with a throttle valve 14 that operates to adjust the amount of intake air. The fuel injection valve 15 injects fuel to be supplied into the corresponding cylinder 11. In each of the multiple cylinders 11, an air-fuel mixture containing air and fuel is combusted by spark discharge of the corresponding ignition plug 16. Accordingly, the crankshaft 12 rotates. The combustion of the air-fuel mixture generates exhaust gas in the cylinders 11. Exhaust gas discharged from the multiple cylinders 11 flows through the exhaust passage 17.

The internal combustion engine 10 is provided with a fuel supply device 20. The fuel supply device 20 supplies fuel stored in a fuel tank 21 to the multiple fuel injection valves 15. The fuel supply device 20 includes a delivery pipe 23 and a fuel supply flow path 22. The delivery pipe 23 temporarily stores fuel to be supplied to the multiple fuel injection valves 15. The fuel supplied from the fuel tank 21 to the delivery pipe 23 flows through the fuel supply flow path 22.

The internal combustion engine 10 includes a purge system 30. The purge system 30 discharges purge gas containing fuel vapor generated in the fuel tank 21 to the intake passage 13. The purge system 30 includes a canister 31, a purge passage 32, a purge port 33, and a purge valve 34. The canister 31 adsorbs fuel vapor generated in the fuel tank 21. In the purge passage 32, purge gas containing vapor of the fuel adsorbed in the canister 31 flows toward the intake passage 13. The purge port 33 is connected to a distal end of the purge passage 32. The purge port 33 discharges the purge gas flowing through the purge passage 32 to a portion of the intake passage 13 downstream of the throttle valve 14. The purge valve 34 is an electronically driven valve provided in the middle of the purge passage 32. The flow rate of the purge gas flowing through the purge passage 32 can be adjusted by controlling the opening degree of the purge valve 34.

### Sensors for the Internal Combustion Engine 10

The internal combustion engine 10 includes multiple sensors that output signals corresponding to detection results to the controller 60. The multiple sensors include an air flow meter 41, a coolant temperature sensor 42, an air-fuel ratio sensor 43, and a concentration sensor 44. The air flow meter 41 detects the flow rate of air flowing through the intake passage 13. The coolant temperature sensor 42 detects the temperature of coolant circulating in the internal combustion engine 10. The air-fuel ratio sensor 43 detects the air-fuel ratio of the air-fuel mixture burned in the multiple cylinders 11. The concentration sensor 44 detects the ethanol concentration of the fuel stored in the fuel tank 21.

Hereinafter, the flow rate of air based on the detection signal of the air flow meter 41 will be referred to as an “intake air amount GA.” The temperature of the coolant based on the detection signal of the coolant temperature sensor 42 is referred to as a “coolant temperature TPw.” The air-fuel ratio based on the detection signal of the air-fuel ratio sensor 43 is referred to as an “air-fuel ratio detection value AF.” The ethanol concentration based on the detection signal of the concentration sensor 44 is referred to as an “ethanol concentration detection value CEt.”

### Controller 60

The controller 60 includes processing circuitry 61 that controls the operation of the internal combustion engine 10. One example of the processing circuitry 61 is an electronic controller. In this case, the processing circuitry 61 includes a CPU 62, a first memory 63, and a second memory 64. The first memory 63 stores various control programs executed by the CPU 62. The second memory 64 stores calculation results of the CPU 62. When the CPU 62 executes the control program of the first memory 63, the processing circuitry 61 can control the fuel injection amounts of the multiple fuel injection valves 15, the opening degree of the throttle valve 14, and the opening degree of the purge valve 34.

Variation in Amount of Purge Gas Introduced into the Cylinders 11

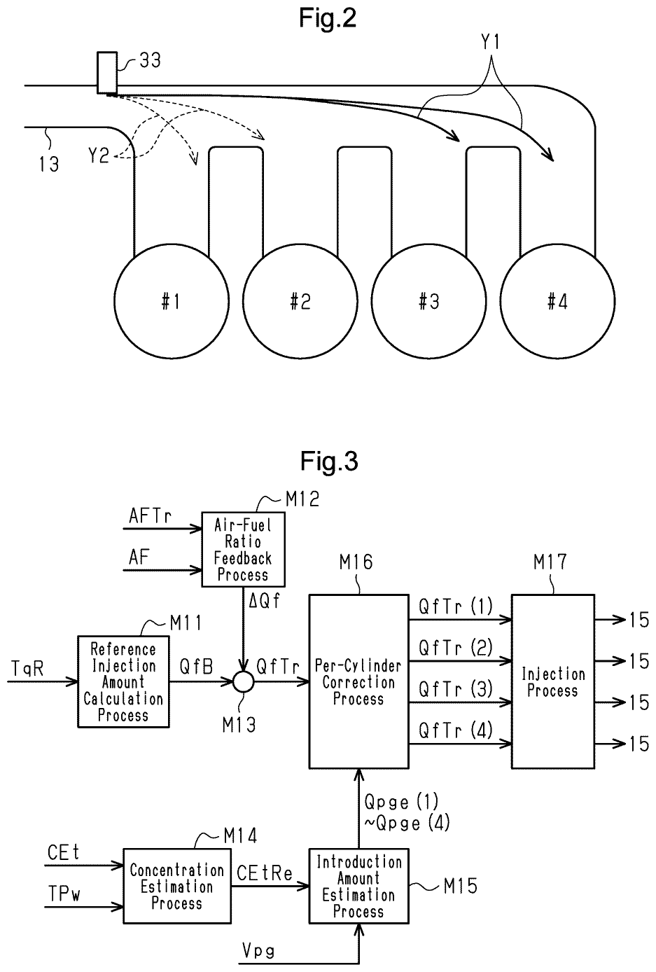

The variation in the amount of purge gas introduced into the cylinders 11 will be described with reference to FIG. 2. In FIG. 2, solid-line arrows Y1 indicate the flow of ethanol components contained in the purge gas, while broken-line arrows Y2 indicate the flow of gasoline components contained in the purge gas.

The specific gravity of ethanol is smaller than that of gasoline. Therefore, the ethanol components contained in the fuel discharged from the purge port 33 to the intake passage 13 are likely to be introduced into the cylinders located away from the purge port 33 among the multiple cylinders #1, #2, #3, and #4, as indicated by arrows Y1 in FIG. 2. That is, among the multiple cylinders #1 to #4, the introduction amount of the ethanol component into the fourth cylinder #4 positioned farthest from the purge port 33 is the largest. On the other hand, among the multiple cylinders #1 to #4, the amount of introduction of the ethanol component into the first cylinder #1 positioned closest to the purge port 33 is the smallest.

The gasoline components contained in the fuel discharged from the purge port 33 to the intake passage 13 are likely to be introduced into the cylinders located near the purge port 33 among the multiple cylinders #1 to #4, as indicated by arrows Y2 in FIG. 2. That is, among the multiple cylinders #1 to #4, the amount of the gasoline component introduced into the first cylinder #1 located closest to the purge port 33 is the largest. On the other hand, among the multiple cylinders #1 to #4, the introduction amount of the gasoline component into the fourth cylinder #4 positioned farthest from the purge port 33 is the smallest.

Therefore, the introduction amount of the purge gas into the cylinder varies among the cylinders #1 to #4. When the ethanol concentration of the purge gas discharged from the purge port 33 to the intake passage 13 changes, the introduction amount of the purge gas into the multiple cylinders #1 to #4 changes. The ethanol concentration of the purge gas discharged from the purge port 33 to the intake passage 13 is referred to as “ethanol concentration CEtR.” For example, when the ethanol concentration CEtR increases, the introduction amount of the purge gas into the cylinder positioned away from the purge port 33 among the multiple cylinders #1 to #4 is likely to increase, whereas the introduction amount of the purge gas into the cylinder located close to the purge port 33 is likely to decrease. On the other hand, when the ethanol concentration CEtR decreases, the introduction amount of the purge gas into the cylinder located close to the purge port 33 among the multiple cylinders #1 to #4 tends to increase, whereas the introduction amount of the purge gas into the cylinder positioned away from the purge port 33 tends to decrease.

When the introduction amount of the purge gas into the multiple cylinders #1 to #4 varies in this way, the air-fuel ratio of the air-fuel mixture burned in the multiple cylinders #1 to #4 varies.

### Various Processes Executed by the Processing Circuitry 61

With reference to FIG. 3, various processes executed by the processing circuitry 61 to adjust the fuel injection amounts of the multiple fuel injection valves 15 so that the variation in the air-fuel ratio of the air-fuel mixture combusted in the multiple cylinders #1 to #4 can be suppressed will be described.

The processing circuitry 61 executes a reference injection amount calculation process M11, an air-fuel ratio feedback process M12, a common correction process M13, a concentration estimation process M14, an introduction amount estimation process M15, a per-cylinder correction process M16, and an injection process M17. Hereinafter, the air-fuel ratio feedback process M12 will be referred to as “air-fuel ratio F/B process M12.”

The reference injection amount calculation process M11 is a process of calculating a basic injection amount QfB which is a basic value of the fuel injection amount of the fuel injection valve 15. In the reference injection amount calculation process M11, the processing circuitry 61 calculates the basic injection amount QfB based on the required torque TqR. For example, the processing circuitry 61 calculates the basic injection amount QfB such that the value of the basic injection amount QfB increases as the required torque TqR increases.

The air-fuel ratio F/B process M12 is a process of calculating a correction injection amount ΔQf which is a correction amount of the fuel injection amount for correcting a deviation between a target air-fuel ratio AFTr which is a target value of the air-fuel ratio and the air-fuel ratio detection value AF. In the air-fuel ratio F/B process M12, the processing circuitry 61 calculates the correction injection amount ΔQf by feedback control in which the deviation between the target air-fuel ratio AFTr and the air-fuel ratio detection value AF is input.

The common correction process M13 is a process of calculating a target injection amount QfTr, which is a target value of the fuel injection amount, by correcting the basic injection amount QfB with the correction injection amount ΔQf. In the common correction process M13, the processing circuitry 61 calculates the sum of the basic injection amount QfB and the correction injection amount ΔQf as the target injection amount QfTr.

The concentration estimation process M14 is a process of estimating the ethanol concentration CEtR of the purge gas discharged from the purge port 33 to the intake passage 13. Hereinafter, the ethanol concentration estimated in the concentration estimation process M14 is referred to as a “concentration estimation value CEtRe.” Specific contents of the concentration estimation process M14 will be described later.

The introduction amount estimation process M15 is a process of estimating the amount of purge gas introduced into the multiple cylinders #1 to #4. Hereinafter, the estimated introduction amount of the purge gas is referred to as an “introduction amount estimation value Qpge(n).” The cylinder number is assigned to “n.” Therefore, the introduction amount estimation value Qpge in the first cylinder #1 is described as “introduction amount estimation value Qpge(1).”

In the introduction amount estimation process M15, the processing circuitry 61 calculates the introduction amount estimation values Qpge(1), Qpge(2), Qpge(3), and Qpge(4) of the multiple cylinders #1 to #4 based on the concentration estimation value CEtRe calculated in the concentration estimation process M14 and the opening degree of the purge valve 34.

Hereinafter, an example of the introduction amount estimation process M15 will be described. The processing circuitry 61 calculates a discharge amount estimated value RLpg, which is an estimated value of the amount of purge gas discharged from the purge port 33 to the intake passage 13, based on the opening degree Vpg of the purge valve 34. For example, the processing circuitry 61 calculates the release amount estimation value RLpg such that the value increases as the opening degree Vpg increases.

Then, the processing circuitry 61 calculates the multiple introduction amount estimation values Qpge(1) to Qpge(4) by allocating the release amount estimation value RLpg to the multiple cylinders #1 to #4 based on the concentration estimation value CEtRe. For example, when the concentration estimation value CEtRe is relatively high, the processing circuitry 61 calculates the multiple introduction amount estimation values Qpge(1) to Qpge(4) such that the assignment of the release amount estimation value RLpg to the cylinders located away from the purge port 33 is large and the assignment of the release amount estimation value RLpg to the cylinders located close to the purge port 33 is small. On the other hand, when the concentration estimation value CEtRe is relatively low, the processing circuitry 61 calculates the multiple introduction amount estimation values Qpge(1) to Qpge(4) so that the assignment of the release amount estimation value RLpg to the cylinders located away from the purge port 33 is small and the assignment of the release amount estimation value RLpg to the cylinders located close to the purge port 33 is large.

Thus, when the concentration estimation value CEtRe is high, the processing circuitry 61 can increase the introduction amount estimation value Qpge(4) of the fourth cylinder #4 located farthest from the purge port 33 among the multiple cylinders #1 to #4, as compared with the case where the concentration estimation value CEtRe is low. Further, the processing circuitry 61 can decrease the introduction amount estimation value Qpge(1) of the first cylinder #1 positioned closest to the purge port 33.

The per-cylinder correction process M16 individually corrects the target injection amounts of the multiple fuel injection valves 15 such that the fuel injection amount of the fuel injection valves 15 corresponding to the cylinders having the large introduction amount estimation value Qpge among the multiple cylinders #1 to #4 is smaller than the fuel injection amount of the fuel injection valves 15 corresponding to the cylinders having the small introduction amount estimation value Qpge.

In the per-cylinder correction process M16, the processing circuitry 61 calculates a decrease correction amount dQf(n) of the fuel injection amount for each of the cylinders #1 to #4. The cylinder number is assigned to “n.” Therefore, the decrease correction amount dQf of the fuel injection amount of the fuel injection valve 15 corresponding to the first cylinder #1 is described as a “decrease correction amount dQf(1).” Hereinafter, the decrease correction amount dQf(n) of the fuel injection amount of the fuel injection valve 15 corresponding to the cylinder #n will be referred to as “decrease correction amount dQf(n) of the cylinder #n.”

An example of a method of calculating the decrease correction amount dQf(1) of the first cylinder #1 will be described. The processing circuitry 61 calculates the decrease correction amount dQf(1) based on the introduction amount estimation value Qpge(1). For example, the processing circuitry 61 calculates the decrease correction amount dQf(1) such that the decrease correction amount dQf(1) increases as the introduction amount estimation value Qpge(1) increases.

The method of calculating the decrease correction amounts dQf(2), dQf(3), and dQf(4) of the cylinders #2, #3, and #4 other than the cylinder #1 is the same as the method of calculating the decrease correction amount dQf(1). Therefore, the description of the method of calculating the decrease correction amounts dQf(2) to dQf(4) is omitted.

Then, the processing circuitry 61 sets a value obtained by subtracting the decrease correction amount dQf(1) from the target injection amount QfTr as a target injection amount QfTr(1) of the fuel injection valve 15 corresponding to the first cylinder #1. The processing circuitry 61 sets a value obtained by subtracting the decrease correction amount dQf(2) from the target injection amount QfTr as a target injection amount QfTr(2) of the fuel injection valve 15 corresponding to the second cylinder #2. The processing circuitry 61 sets a value obtained by subtracting the decrease correction amount dQf(3) from the target injection amount QfTr as a target injection amount QfTr(3) of the fuel injection valve 15 corresponding to the third cylinder #3. The processing circuitry 61 sets a value obtained by subtracting the decrease correction amount dQf(4) from the target injection amount QfTr as a target injection amount QfTr(4) of the fuel injection valve 15 corresponding to the forth cylinder #4.

The injection process M17 is a process of controlling the fuel injection of the multiple fuel injection valves 15 by adjusting the energization to the multiple fuel injection valves 15. In the injection process M17, the processing circuitry 61 operates the fuel injection valves 15 corresponding to the cylinders #1 based on the target injection amount QfTr(1). The processing circuitry 61 operates the fuel injection valves 15 corresponding to the cylinders #2 based on the target injection amount QfTr(2). The processing circuitry 61 operates the fuel injection valve 15 corresponding to the cylinders #3 based on the target injection amount QfTr(3). The processing circuitry 61 operates the fuel injection valve 15 corresponding to the cylinders #4 based on the target injection amount QfTr(4).

### Concentration Estimation Process M14

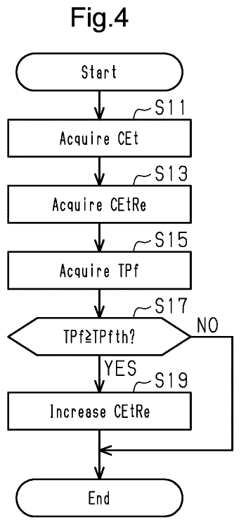

An example of a series of processes indicating the concentration estimation process M14 will be described with reference to FIG. 4. The processing circuitry 61 repeatedly executes the concentration estimation process M14 for each specified control cycle.

In step S11, the processing circuitry 61 acquires an ethanol concentration detection value CEt which is a detection value of the ethanol concentration of the fuel stored in the fuel tank 21. In the subsequent step S13, the processing circuitry 61 calculates a concentration estimation value CEtRe which is an estimation value of the ethanol concentration CEtR of the purge gas discharged from the purge port 33 to the intake passage 13. For example, the processing circuitry 61 calculates the ethanol concentration detection value CEt acquired in step S11 as the concentration estimation value CEtRe. Then, the processing circuitry 61 shifts the processing to step S15.

The volatility of gasoline is not so much dependent on temperature. On the other hand, the volatility of ethanol varies depending on the temperature. When the temperature of the ethanol exceeds the specified temperature, the volatilization amount of the ethanol rapidly increases as compared with the case where the temperature of the ethanol is equal to or lower than the specified temperature. That is, even if the ethanol concentration of the fuel stored in the fuel tank 21 is the same, the ethanol concentration CEtR of the purge gas discharged from the purge port 33 to the intake passage 13 can change depending on whether the temperature of the fuel is higher than the specified temperature.

Therefore, in step S15, the processing circuitry 61 acquires the fuel temperature TPf, which is the temperature of the fuel stored in the fuel tank 21. For example, the processing circuitry 61 acquires an estimated value of the temperature of the fuel based on the coolant temperature TPw as the fuel temperature TPf. At this time, the processing circuitry 61 may calculate the estimated value of the temperature of the fuel so that the higher the coolant temperature TPw, the larger the value. The processing circuitry 61 may acquire an estimated value of the temperature of the fuel based on the temperature of the oil circulating in the internal combustion engine 10 as the fuel temperature TPf. When a sensor that detects the temperature in the fuel tank 21 is provided, the processing circuitry 61 may acquire the detection value of the sensor as the fuel temperature TPf.

In subsequent step S17, the processing circuitry 61 determines whether the fuel temperature TPf acquired in step S15 is higher than or equal to a specified temperature TPfth. The specified temperature TPfth is a criterion for determining whether the temperature is a temperature at which ethanol easily volatilizes. For example, the specified temperature TPfth is set to the specified temperature described above or a temperature corresponding to the specified temperature. When the fuel temperature TPf is higher than or equal to the specified temperature TPfth (S17: YES), the processing circuitry 61 shifts the processing to step S19. When the fuel temperature TPf is lower than the specified temperature TPfth (S17: NO), the processing circuitry 61 temporarily ends the concentration estimation process M14 without executing the processing of step S19.

In step S19, the processing circuitry 61 corrects to increase the concentration estimation value CEtRe acquired in step S13. For example, the processing circuitry 61 calculates the product of the concentration estimation value CEtRe acquired in step S13 and the correction gain Gn as the corrected concentration estimation value CEtRe. The correction gain Gn is a value larger than 1. That is, when the fuel temperature TPf is higher than or equal to the specified temperature TPfth, the processing circuitry 61 can increase the concentration estimation value CEtRe as compared with the case where the fuel temperature TPf is lower than the specified temperature TPfth. Then, the processing circuitry 61 temporarily ends the concentration estimation process M14.

### Operation and Advantages of the Present Embodiment

(1) When purge gas is discharged from the purge port 33 to the intake passage 13 during the operation of the internal combustion engine 10, the processing circuitry 61 individually corrects the fuel injection amounts of the multiple fuel injection valves 15 corresponding to the multiple cylinders #1 to #4 by executing the per-cylinder correction process M16. Specifically, the processing circuitry 61 sets the target injection amounts QfTr(1) to QfTr(4) such that the fuel injection amount of the fuel injection valve 15 corresponding to a cylinder into which a large amount of purge gas is introduced among the multiple cylinders #1 to #4 is smaller than the fuel injection amount of the fuel injection valve 15 corresponding to the cylinder into which a small amount of purge gas is introduced. Then, the processing circuitry 61 operates the fuel injection valves 15 based on the target injection amounts QfTr(1) to QfTr(4).

Accordingly, the controller 60 suppresses variation among the cylinders #1 to #4 in the sum of the fuel injection amount of each fuel injection valve 15 and the introduced amount of purge gas. Therefore, the controller 60 can suppress variation among the cylinders #1 to #4 in the air-fuel ratio of the mixture combusted within each cylinder.

(2) The ethanol component of the purge gas discharged from the purge port 33 to the intake passage 13 is likely to be guided to a cylinder located away from the purge port 33 among the multiple cylinders #1 to #4. The gasoline component of the purge gas is likely to be guided to a cylinder located near the purge port 33 among the multiple cylinders #1 to #4.

Accordingly, the processing circuitry 61 executes the concentration estimation process M14 to calculate a concentration estimation value CEtRe, which is an estimation value of the ethanol concentration of the purge gas discharged from the purge port 33 to the intake passage 13. In the introduction amount estimation process M15, in a case in which the concentration estimation value CEtRe is relatively large, the processing circuitry 61 estimates that the introduction amount of purge gas into the fourth cylinder #4, which is farthest from the purge port 33 among the cylinders #1 to #4, is relatively large, and that the introduction amount of purge gas into the first cylinder #1, which is closest to the purge port 33, is relatively small, as compared with a case in which the concentration estimation value CEtRe is relatively small.

The processing circuitry 61 sets the target injection amounts QfTr(1) to QfTr(4) based on the result of the introduction amount estimation process M15. Then, the processing circuitry 61 operates the fuel injection valves 15 based on the target injection amounts QfTr(1) to QfTr(4). In this manner, the processing circuitry 61 can individually adjust the fuel injection amounts of the fuel injection valves 15 in consideration of the respective amounts of purge gas introduced into the respective cylinders #1 to #4.

(3) The processing circuitry 61 calculates the concentration estimation value CEtRe based on whether the fuel temperature TPf, which is the temperature of the fuel stored in the fuel tank 21, is higher than or equal to the specified temperature TPfth. In other words, the processing circuitry 61 can calculate the concentration estimation value CEtRe in consideration of the volatility of ethanol. Accordingly, the processing circuitry 61 can accurately estimate the ethanol concentration of the purge gas discharged from the purge port 33 to the intake passage 13.

### Modifications

The above-described embodiment may be modified as described below. The above-described embodiment and the following modifications can be combined as long as the combined modifications remain technically consistent with each other.

Even when the introduction amounts of the purge gas into the multiple cylinders #1 to #4 are substantially the same, a variation in the air-fuel ratio of the air-fuel mixture combusted in the multiple cylinders #1 to #4 may occur. The combustion characteristics of ethanol differ from those of gasoline. Therefore, when the ethanol concentration in the purge gas introduced into the multiple cylinders #1 to #4 varies, the air-fuel ratio of the air-fuel mixture burned in the multiple cylinders #1 to #4 may vary.

Therefore, the processing circuitry 61 estimates the ethanol concentration of the purge gas introduced into the cylinder from the intake passage 13 for each of the cylinders #1 to #4. Then, the processing circuitry 61 may individually correct the fuel injection amounts of the multiple fuel injection valves 15 so that the fuel injection amount of the fuel injection valve 15 corresponding to the cylinder becomes larger when the ethanol concentration of the purge gas introduced into the cylinder from the intake passage 13 is high than when the ethanol concentration is low. Thus, the processing circuitry 61 can further enhance the effect of suppressing the variation in the air-fuel ratio of the air-fuel mixture burned in the cylinder among the cylinders #1 to #4.

When the ethanol concentration of the fuel supplied to the multiple fuel injection valves 15 by the fuel supply device 20 changes, the air-fuel ratio detection value AF changes. Therefore, the processing circuitry 61 may estimate the concentration of ethanol stored in the fuel tank 21 based on the air-fuel ratio detection value AF.

The processing circuitry 61 may calculate the concentration estimation value CEtRe without considering whether the fuel temperature TPf, which is the temperature of the fuel stored in the fuel tank 21, is higher than or equal to the specified temperature TPfth. In this case, the concentration estimation process may be a process in which the processes of steps S15, S17, and S19 in FIG. 4 are omitted.

The internal combustion engine to which the controller 60 is applied may have a configuration different from that of the internal combustion engine 10 shown in FIG. 1 as long as two or more cylinders are arranged in the direction in which the crankshaft 12 extends. For example, the internal combustion engine may have a configuration in which three cylinders are arranged in the direction in which the crankshaft 12 extends.

The processing circuitry 61 is not limited to a device that includes a CPU and a ROM and executes software processing. That is, the controller 60 may have any one of the following configurations (a), (b), and (c).

(a) The processing circuitry 61 includes one or more processors that execute various processes in accordance with a computer program. Each processor includes a CPU and a memory, such as a RAM and a ROM. The memory stores program codes or instructions configured to cause the CPU to execute processes. The memory, or a computer-readable medium, includes any type of medium that is accessible by general-purpose computers and dedicated computers.

(b) The processing circuitry 61 includes one or more exclusive hardware circuits that execute various processes. Examples of the dedicated hardware circuits include an application specific integrated circuit (ASIC) and a field programmable gate array (FPGA).

(c) The processing circuitry 61 includes one or more processors that execute part of various processes according to programs and one or more dedicated hardware circuits that execute the remaining processes.

The expression “at least one” as used herein means “one or more” of desired options. In one example, the phrase “at least one of” as used in this disclosure means “only one single choice” or “both of two choices” if the number of its choices is two. As another example, the expression “at least one” used herein means “only one option” or “a combination of any two or more options” if the number of options is three or more.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An internal combustion engine controller for controlling an internal combustion engine, wherein
the internal combustion engine is capable of using a fuel containing ethanol,
the internal combustion engine includes:
multiple cylinders;
multiple fuel injection valves respectively corresponding to the cylinders;
an intake passage through which air is drawn into the cylinders; and
a purge port that discharges purge gas containing fuel vapor generated in a fuel tank to the intake passage,
the internal combustion engine controller includes processing circuitry configured to control fuel injection amounts of the fuel injection valves, and
the processing circuitry is configured to execute a per-cylinder correction process that individually corrects fuel injection amounts of the fuel injection valves such that a fuel injection amount of the fuel injection valve corresponding to a cylinder into which a large amount of the purge gas is introduced among the multiple cylinders is smaller than a fuel injection amount of the fuel injection valve corresponding to a cylinder into which a small amount of the purge gas is introduced.

2. The internal combustion engine controller according to claim 1, wherein the processing circuitry is configured to execute
a concentration estimation process that estimates an ethanol concentration of the purge gas discharged from the purge port to the intake passage; and
an introduction amount estimation process that, in a case in which the ethanol concentration is relatively high, estimates that an introduction amount of the purge gas into one of the cylinders that is farthest from the purge port is relatively large, and that an introduction amount of the purge gas into one of the cylinders that is closest to the purge port is relatively small, as compared with a case in which the ethanol concentration is relatively low.

3. The internal combustion engine controller according to claim 2, wherein the processing circuitry is configured to, in the concentration estimation process
determine whether a temperature of the fuel stored in the fuel tank is higher than or equal to a specified temperature, and
estimate the ethanol concentration of the purge gas to be higher when determining that the temperature of the fuel stored in the fuel tank is higher than or equal to the specified temperature than when determining that the temperature of the fuel is lower than the specified temperature.
